(19) United States
(12) Patent Application Publication
(10) Pub. No.: US 2025/0153299 A1
(43) Pub. Date: May 15, 2025

(54) ON-MACHINE TOOL MEASUREMENT DEVICE

(71) Applicant: SHIBAURA MACHINE CO., LTD., Tokyo (JP)

(72) Inventors: Takayuki NONAKA, Shizuoka (JP); Yutaka ASANOME, Shizuoka (JP)

(73) Assignee: SHIBAURA MACHINE CO., LTD., Tokyo (JP)

(21) Appl. No.: 18/835,252

(22) PCT Filed: Dec. 27, 2022
(86) PCT No.: PCT/JP2022/048064

§ 371 Date: Aug. 1, 2024

(30) Foreign Application Priority Data
Feb. 9, 2022 (JP) 2022-018989

(51) Int. Cl. B23Q 17/22

(52) U.S. Cl. CPC B23Q 17/22

(57) ABSTRACT

An on-machine tool-measurement device is installed on a machine tool configured to machine a workpiece placed on a table using a tool attached to a spindle and is configured to measure conditions of the tool within a measurement area for the tool. The on-machine tool-measurement device includes a measuring unit for measuring the conditions of the tool, a support base that supports the measuring unit, and a moving mechanism for moving the support base to locate the measuring unit within or outside the measurement area for the tool.

### TECHNICAL FIELD

The present invention relates to an on-machine tool-measurement device.

### BACKGROUND ART

A machine tool is configured to perform the machining process of a workpiece using a tool attached to a spindle. The tool abrades in accordance with operation time, and accordingly, it is necessary in terms of control to correct the edge position of the tool or exchange the tool. In order to automate measurement of abrasion of the tool, some of machine tools are provided with an on-machine tool-measurement device (see Patent Literature 1).

The on-machine tool-measurement device is configured to, for instance, take a two-dimensional image of a tool attached to a spindle rotated at a high speed to automatically measure the conditions of the tool. After calibrating the edge position of the tool in accordance with measurement results of the tool measurement device, an NC device of the machine tool performs the machining process.

### CITATION LIST

### Patent Literature(s)

Patent Literature 1: JP 2018-051725 A

### SUMMARY OF THE INVENTION

### Problem(s) to be Solved by the Invention

The above-described on-machine tool-measurement device includes a measuring unit provided within a movable area of the spindle of the machine tool, such as on an upper side of a corner of a table where a workpiece is to be placed, in order to measure the tool.

The measuring unit is placed at such a portion, thereby occupying a certain space on the table and restricting the size of the workpiece placeable on the table. Especially, when a plurality of measuring units configured to measure different items are placed on the table, the workpiece placeable on the table is further restricted to be smaller in size.

Further, the measuring unit(s) of the on-machine tool-measurement device is provided on the table, and is therefore exposed to machined chips and coolant liquid to get dirty in the machining process.

In addition, in some of the machine tools in which a table such as a vertical lathe is infinitely rotatable, the measuring unit cannot be placed on the table for the convenience of wiring and the like.

An object of the invention is to provide an on-machine tool-measurement device capable of reducing or eliminating an occupied space on a table.

Another object of the invention is to provide an on-machine tool-measurement device involving no increase in occupied space on a table irrespective of increase in the number of items to be measured.

### Means for Solving the Problem(s)

An on-machine tool-measurement device according to an aspect of the invention is installed to a machine tool configured to machine a workpiece placed on a table using a tool attached to a spindle, the on-machine tool-measurement device being configured to measure a condition of the tool, the on-machine tool-measurement device including: a measuring unit configured to measure a condition of the tool; a support base that supports the measuring unit; and a moving mechanism configured to move the support base to locate the measuring unit within a measurement area for the tool or outside the measurement area.

According to the above aspect of the invention, the support base and the measuring unit can be moved by the moving mechanism, so that the conditions of the tool can be measured with the measuring unit being located within the measurement area for the tool and an occupied space within a movable range of the tool on the table or the like can be reduced or eliminated by locating the measuring unit outside the measurement area for the tool.

As an exemplary structure of the support base and the moving mechanism, a structure can be employed in which the support base is rotated or translated in a horizontal direction or vertical direction, and a structure can be employed in which one of the measuring unit(s) supported by the support base can be located within the measurement area for the tool and moved out of a measurable range.

In the on-machine tool-measurement device according to the above aspect of the invention, it is preferable that the measuring unit is provided by a plurality of measuring units supported by the support base, one of the plurality of measuring units being configured to be located within the measurement area for the tool by moving the support base.

According to the above arrangement, a plurality of types of the conditions of the tool can be measured by the plurality of measuring units. Further, since only one of the plurality of measuring units is located within the measurement area for the tool, the occupied space on the table does not increase even when the number of items to be measured increases.

In the on-machine tool-measurement device according to the above aspect of the invention, it is preferable that the support base is supported in a manner rotatable around a vertical axis.

According to the above arrangement, the structure can be simplified and the size can be reduced as compared with a structure in which a support base is translated.

In the on-machine tool-measurement device according to the above aspect of the invention, it is preferable that the moving mechanism includes a shaft member that supports the support base, a body that supports the shaft member in a rotatable manner, a vertical drive mechanism configured to drive the shaft member to vertically move with respect to the body, and an inclined cam mechanism provided between the shaft member and the body and configured to rotate the shaft member in accordance with a vertical movement of the shaft member.

According to the above arrangement, a movable distance of the support base can be secured by rotating the support base while vertically moving the support base. Further, the support base can be rotated through the upward/downward movement of the support base, so that the structure of the moving mechanism can be simplified.

According to the above aspect of the invention, an on-machine tool-measurement device capable of reducing or eliminating an occupied space on a table can be provided. Further, according to the above aspect of the invention, an on-machine tool-measurement device involving no increase in the occupied space on a table irrespective of increase in the number of items to be measured can be provided.

### BRIEF DESCRIPTION OF DRAWINGS

FIG. 1 is an elevational view illustrating a machine tool according to an exemplary embodiment of the invention.

FIG. 2 is a plan view illustrating a table, a measuring unit, and a support base of the exemplary embodiment.

FIG. 3 is an elevational view illustrating the table, the measuring unit, and the support base of the exemplary embodiment.

FIG. 4 is an elevational view illustrating a moving mechanism of the exemplary embodiment.

FIG. 5 is a developed view of a side face of a shaft member illustrating an inclined cam mechanism of the exemplary embodiment.

FIG. 6A is a plan view illustrating an operation in the exemplary embodiment.

FIG. 6B is another plan view illustrating an operation in the exemplary embodiment.

FIG. 6C is still another plan view illustrating an operation in the exemplary embodiment.

### DESCRIPTION OF EMBODIMENT(S)

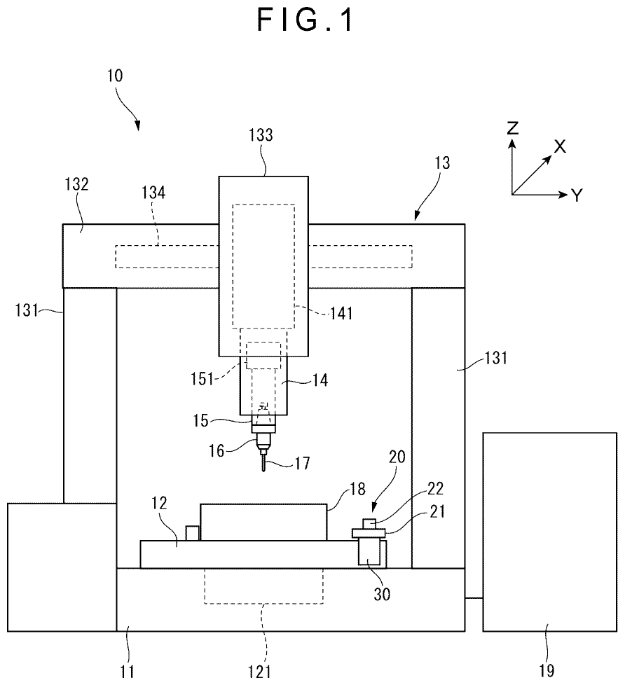

FIGS. 1 to 6C illustrate an exemplary embodiment of the invention.

As illustrated in FIG. 1, a machine tool 10 includes a bed 11 and a table 12 provided on an upper side of the bed 11. The table 12, on an upper side of which a workpiece 18 to be machined is placed, is movable to a desired position in an X-axis direction (i.e. a direction orthogonal to the drawing sheet) with respect to the bed 11 by an X-axis movement mechanism 121.

A pair of columns 131 are each provided on corresponding one of sides of the bed 11, and a cross rail 132 is provided to connect upper ends of the columns 131. A saddle 133 is supported by the cross rail 132. The columns 131, the cross rail 132, and the saddle 133 configure a spindle movement mechanism 13 with a portal shape. The saddle 133 is movable along the cross rail 132 in a Y-axis direction by a Y-axis movement mechanism 134.

A spindle head 14 extending downward is supported by the saddle 133. The spindle head 14 is movable in up and down directions (i.e., movable in a Z-axis direction) with respect to the saddle 133 by a Z-axis movement mechanism 141. A spindle 15 is rotatably supported by the spindle head 14, and is driven to be rotated by a motor 151. A tool holder 16 is attached to an end of the spindle 15, and a tool 17 is attached to an end of the tool holder 16.

A controller 19 is connected to the machine tool 10. Under the control of the controller 19, the spindle 15 or the end of the tool 17 is moved to a desired point in three axes, i.e., X, Y and Z axes, by the X-axis movement mechanism 121, the Y-axis movement mechanism 134 and the Z-axis movement mechanism 141, and the tool 17 is driven to be rotated by the motor 151, and these collaborative operations allows the workpiece 18 on the table 12 to be machined into a desired shape.

An on-machine tool-measurement device 20 according to the exemplary embodiment of the invention is provided on the machine tool 10 in order to measure a change in the conditions of the tool 17 caused by the machining process.

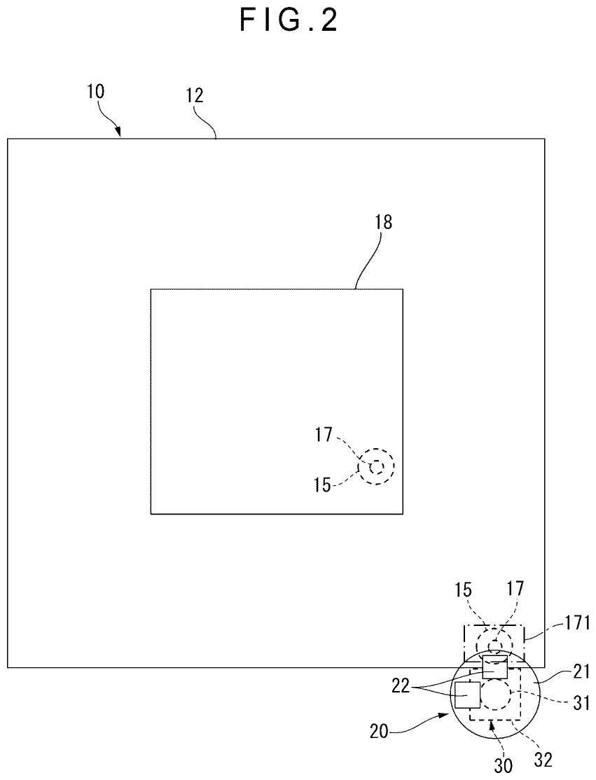

The on-machine tool-measurement device 20, which is configured to measure the tool 17 in a measurement area 171 (see FIG. 2) on the upper side of the table 12, includes a support base 21 a part of which can be located within the measurement area 171, measuring units 22 supported by the support base 21 to measure the conditions of the tool 17, and a moving mechanism 30 for moving the support base 21 so that the measuring units 22 are located inside or outside the measurement area 171 for the tool 17.

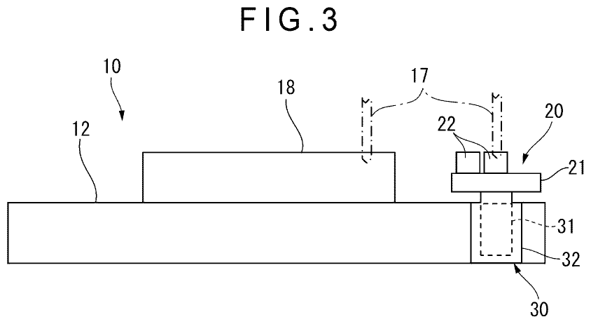

As illustrated in FIGS. 2 and 3, the on-machine tool-measurement device 20 is provided at a corner of the table 12.

The moving mechanism 30 includes a body 32 fixed on a side face of the table 12, and a shaft member 31 vertically supported by the body 32.

The support base 21, which is a disc-shaped component supported by an upper end of the shaft member 31, is supported in a manner rotatable around a vertical axis by the moving mechanism 30.

Two measuring units 22 are provided on an upper side of the support base 21.

The rotation of the support base 21 allows one of the two measuring units 22 to be moved into the measurement area 171 for the tool 17, and at this time, the other of the measuring units 22 is kept outside the measurement area 171.

Accordingly, the conditions of the tool 17 can be measured by rotating the support base 21 to move the one of the measuring units 22 used for the measurement into the measurement area 171 and bring the tool 17 close to the one of the measuring units 22. Also, a different item can be measured by rotating the support base 21 to move the other of the measuring units 22 into the measurement area 171.

The two measuring units 22, which are positioned to form a 90 degrees angle with each other around a rotation center of the support base 21, are configured to alternately be moved into the measurement area 171 by a 90-degree rotation of the support base 21. In contrast, when the support base 21 is rotated to a different angle position, both of the two measuring units 22 can be evacuated out of the measurement area 171.

As described above, the moving mechanism 30 includes the body 32 fixed on the side face of the table 12 and the shaft member 31 vertically supported by the body 32.

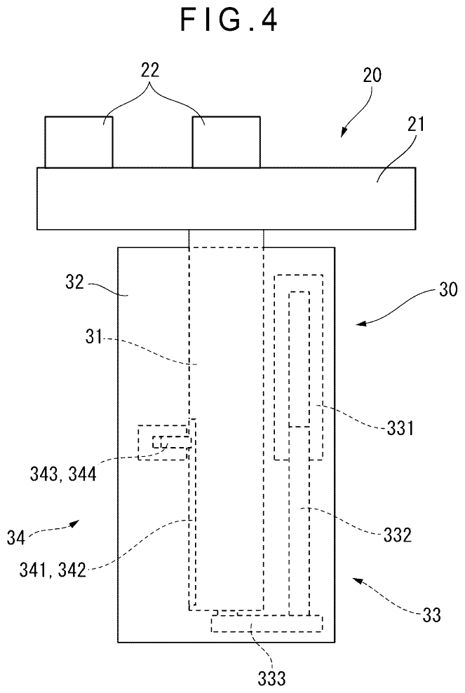

Further, in order to move the support base 21 to locate the measuring units 22 inside or outside the measurement area 171 for the tool 17, the moving mechanism 30 includes a vertical drive mechanism 33 configured to drive the shaft member 31 to vertically move with respect to the body 32, and an inclined cam mechanism 34 provided between the shaft member 31 and the body 32 and configured to rotate the shaft member 31 in accordance with the vertical movement of the shaft member 31 (see FIG. 4).

As illustrated in FIG. 4, inside the body 32, an air cylinder 331 is installed along the shaft member 31, and a lever 333 is fixed to an end of a rod 332 extending from the air cylinder 331. The rod 332 is movable upward or downward by supplying or discharging drive air into or out of the air cylinder 331. A part of the lever 333 is in contact with a central part of a lower end of the shaft member 31 in a slidable manner. Specifically, the lever 333 and the shaft member 31 are connected via a radial bearing or thrust bearing rotatable concentrically with the shaft member 31, so that the shaft member 31 is rotatable with respect to the lever 333 and is upwardly movable in accordance with upward movement of the lever 333.

The shaft member 31 is supported in a manner rotatable with respect to the body 32 and movable in an axial direction, i.e., vertically movable, so that the shaft member 31 is upwardly movable in accordance with upward movement of the rod 332 and the lever 333 by the above-described air cylinder 331 and is downwardly movable due to self-weight in accordance with downward movement of the rod 332 and the lever 333 by the air cylinder 331.

The air cylinder 331, the rod 332, and the lever 333 configure the vertical drive mechanism 33 for driving the shaft member 31 to vertically move with respect to the body 32.

A pair of cam grooves 341 and 342 vertically extending are provided on a side face of the shaft member 31. A pair of engagement pins 343 and 344 respectively engageable with the cam grooves 341 and 342 are provided on the body 32. The engagement pins 343 and 344 are configured to protrude or retract from/into an inside of the body 32 toward/away from the shaft member 31 by a solenoid and the like, so that it is selectable whether the engagement is made between the engagement pin 343 and the cam groove 341 or between the engagement pin 344 and the cam groove 342.

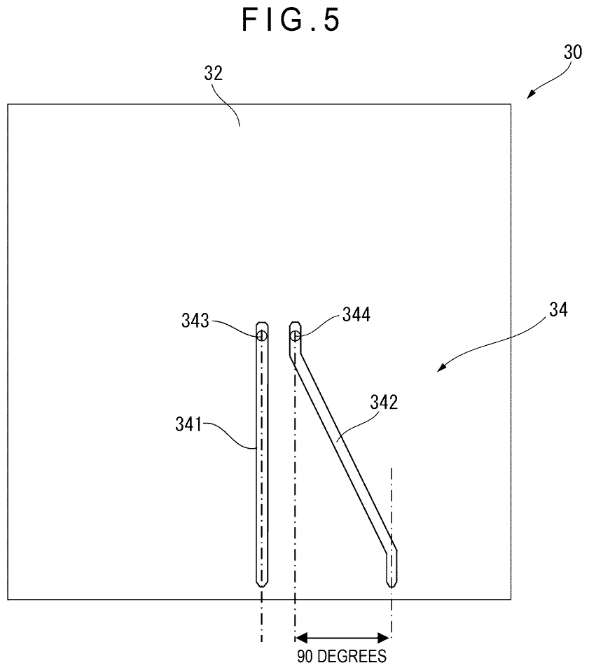

FIG. 5 is a developed view of the side face of the shaft member 31 with a cylindrical shape.

As illustrated in FIG. 5, the cam groove 341 extends along a center axis line of the shaft member 31. Accordingly, when the shaft member 31 is vertically moved with the engagement pin 343 being engaged with the cam groove 341, the shaft member 31 does not rotate around the center axis line.

In contrast, while upper and lower ends of the cam groove 342 extend along the center axis line of the shaft member 31, an intermediate part of the cam groove 342 is slanted with respect to the center axis line of the shaft member 31 to form a spiral on the side face of the shaft member 31 with a cylindrical shape. When the shaft member 31 is vertically moved with the engagement pin 344 being engaged with the cam groove 342, the shaft member 31 rotates around the center axis line at the inclined part of the cam groove 342. The cam groove 342 is configured so that a rotary angle of the shaft member 31 becomes 90 degrees when the shaft member 31 is vertically moved between the upper and lower ends thereof.

The cam grooves 341 and 342 and the engagement pins 343 and 344 configure the inclined cam mechanism 34 that is provided between the shaft member 31 and the body 32 and rotates the shaft member 31 in accordance with the vertical movement of the shaft member 31.

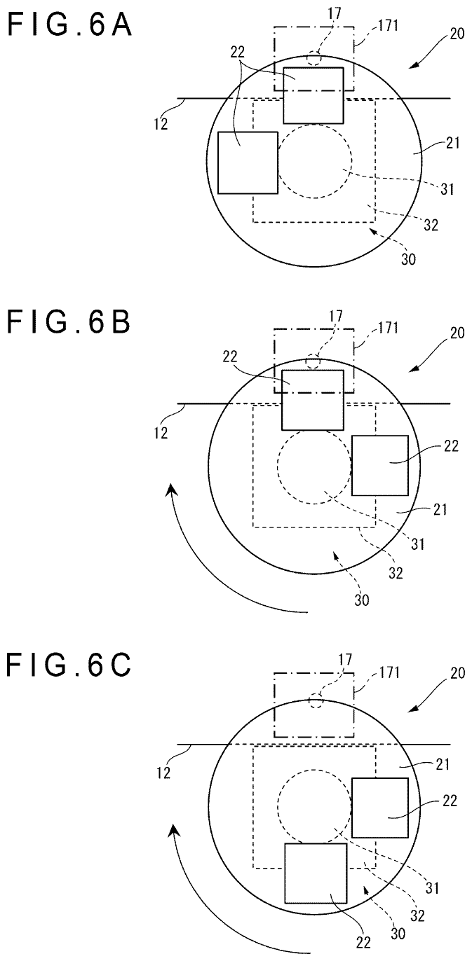

FIGS. 6A to 6C illustrate switching motion of the measuring units 22 of the on-machine tool-measurement device 20 according to the exemplary embodiment.

In the state illustrated in FIG. 6A, one of the two measuring units 22 is located within the measurement area 171 for the tool 17 (an upper side in FIG. 6). In this state, when the engagement pin 343 is brought into engagement with the cam groove 341 and the shaft member 31 is moved upward by the vertical drive mechanism 33, the shaft member 31 and the support base 21 are moved upward without being rotated, and accordingly the conditions of the tool 17 can be measured with the use of the one of the measuring units 22 that has been already located within the measurement area 171. When the measurement is completed, the shaft member 31 is lowered.

Subsequently, when the shaft member 31 is moved upward by the vertical drive mechanism 33 with the engagement pin 344 being engaged with the cam groove 342, the shaft member 31 and the support base 21 are rotated by 90 degrees while being upwardly moved.

As illustrated in FIG. 6B, as the support base 21 is rotated by 90 degrees, the one of the measuring units 22 having been located within the measurement area 171 (an upper side in FIG. 6B) is transferred out of the measurement area 171 (a right side in FIG. 6B) and, also the other of the measuring units 22 having been located outside the measurement area 171 (a left side in FIG. 6B) is moved into the measurement area 171 (the upper side in FIG. 6B), and accordingly the conditions of the tool 17 can be measured with the use of the other of the measuring units 22.

After completing the measurement, the shaft member 31 is lowered, and thereby the support base 21 is reversely rotated by 90 degrees, so that the status illustrated in FIG. 6A is restored.

In contrast, the support base 21 can be further rotated by 90 degrees by disengaging the engagement pin 344 from the cam groove 342 in the state illustrated in FIG. 6B, lowering the shaft member 31 with the engagement pin 343 being engaged with the cam groove 341, also engaging again the engagement pin 344 with the cam groove 342 at the lowermost position of the shaft member 31, and upwardly moving the shaft member 31.

As illustrated in FIG. 6C, both of the two measuring units 22 are located outside the measurement area 171, so that the space in the measurement area 171 on the table 12 can be kept from being occupied by the measuring units 22.

According to the exemplary embodiment, the support base 21 and the measuring units 22 can be moved by the moving mechanism 30, so that the conditions of the tool 17 can be measured with one of the measuring units 22 being located within the measurement area 171 for the tool 17 and the other of the measuring units 22 not used for the measurement can be located outside the measurement area 171 for the tool 17. Accordingly, the space on the table 12 occupied by one of the measuring units 22 unused for the measurement can be reduced or eliminated.

Especially, according to the exemplary embodiment, a plurality of the measuring units 22 are supported by the support base 21 and one of the measuring units 22 can be located within the measurement area 171 for the tool 17 by moving the support base 21. Accordingly, a plurality of types of the conditions of the tool 17 can be measured by the plurality of measuring units 22. Further, since only one of the plurality of measuring units 22 is located within the measurement area 171 for the tool 17, the occupied space on the table 12 does not increase even when the number of items to be measured increases.

In the exemplary embodiment, since the support base 21 is rotatably supported around a vertical axis, the support base 21 can be simplified in structure and reduced in size as compared with a structure in which support base 21 is translated.

Further, in the exemplary embodiment, the moving mechanism 30 includes the shaft member 31 for supporting the support base 21, the body 32 for supporting the shaft member 31 in a rotatable manner, the vertical drive mechanism 33 configured to drive the shaft member 31 to vertically move with respect to the body 32, and the inclined cam mechanism 34 provided between the shaft member 31 and the body 32 and configured to rotate the shaft member 31 in accordance with the vertical movement of the shaft member 31, and therefore a movable distance of the support base 21 can be secured by rotating the support base 21 while vertically moving the support base 21. Further, the support base 21 can be rotated using the upward/downward movement of the support base 21, so that the structure of the moving mechanism 30 can be simplified.

It should be noted that the invention is not limited to the above-described exemplary embodiments but includes modifications and the like as long as such modifications and the like are compatible with an object of the invention.

In the above exemplary embodiment, the orientation of the measuring units 22 is selectably changed, by the switching operation of the inclined cam mechanism 34 in three modes, where one of the measuring units 22 is located within the measurement area 171 for the tool 17 (the status illustrated in FIG. 6A), the other of the measuring units 22 is located within the measurement area 171 (the status illustrated in FIG. 6B), and both of the two measuring units 22 are evacuated out of the measurement area 171 (the status illustrated in FIG. 6C).

In contrast, the mode for evacuating both of the two measuring units 22 out of the measurement area 171 (the status illustrated in FIG. 6C) may be omitted, and one of the two measuring units 22 may be located within the measurement area 171 (the status illustrated in FIG. 6A or 6B). In this case, although the space occupied by the measuring unit(s) 22 on the table 12 cannot be eliminated, increase in the occupied space on the table 12 caused by the use of the plurality of measuring units 22 can be restrained, i.e., the occupied space can be reduced.

Although the two measuring units 22 are installed on the support base 21 and one of the measuring units 22 is located on the table 12 in the above exemplary embodiment, three or more measuring units 22 may be provided and any one of the three or more measuring units 22 may be located on the table 12.

Although the support base 21 is rotatably supported by the shaft member 31 and is rotated in accordance with the vertical movement thereof by the moving mechanism 30 using a cam in the above exemplary embodiment, only the rotation operation may be performed without the vertical movement operation. In this case, another drive mechanism for rotating the shaft member 31, e.g., an electric motor and a transmission mechanism such as a gear mechanism and a belt pulley, may be used.

Although the on-machine tool-measurement device 20 is installed at the corner of the table 12 in the above exemplary embodiment, the on-machine tool-measurement device 20 may be installed on other part of the machine tool 10 such as on the bed 11 or on the column(s) 131.

### INDUSTRIAL APPLICABILITY

The invention is applicable to an on-machine tool-measurement device.

### EXPLANATION OF CODES

10 . . . machine tool, 11 . . . bed, 12 . . . table, 121 . . . . X-axis movement mechanism, 13 . . . spindle movement mechanism, 131 . . . column, 132 . . . cross rail, 133 . . . saddle, 134 . . . . Y-axis movement mechanism, 14 . . . spindle head, 141 . . . . Z-axis movement mechanism, 15 . . . spindle, 151 . . . motor, 16 . . . tool holder, 17 . . . tool, 171 . . . measurement area, 18 . . . workpiece, 19 . . . controller, 20 . . . on-machine tool-measurement device, 21 . . . support base, 22 . . . measuring unit, 30 . . . moving mechanism, 31 . . . shaft member, 32 . . . body, 33 . . . vertical drive mechanism, 331 . . . air cylinder, 332 . . . rod, 333 . . . lever, 34 . . . inclined cam mechanism, 341, 342 . . . cam grooves, 343, 344 . . . engagement pins.

1. An on-machine tool-measurement device installed to a machine tool configured to machine a workpiece placed on a table using a tool attached to a spindle, the on-machine tool-measurement device being configured to measure a condition of the tool, the on-machine tool-measurement device comprising:
a measuring unit configured to measure the condition of the tool;
a support base configured to support the measuring unit; and
a moving mechanism configured to move the support base to selectively locate the measuring unit:
within a measurement area for the tool, and
outside the measurement area.

2. The on-machine tool-measurement device according to claim 1, further comprising a plurality of measuring units supported by the support base, wherein the measuring unit comprises one of the plurality of measuring units.

3. The on-machine tool-measurement device according to claim 1, wherein the support base is supported in a manner rotatable around a vertical axis.

4. The on-machine tool-measurement device according to claim 3, wherein the moving mechanism comprises:
a shaft member configured to support the support base;
a body configured to support the shaft member in a rotatable manner;
a vertical drive mechanism configured to drive the shaft member to vertically move with respect to the body; and
an inclined cam mechanism provided between the shaft member and the body and configured to rotate the shaft member in accordance with a vertical movement of the shaft member.

5. The on-machine tool-measurement device according to claim 2, wherein the support base is supported in a manner rotatable around a vertical axis.

6. The on-machine tool-measurement device according to claim 5, wherein the moving mechanism comprises:
a shaft member configured to support the support base;
a body configured to support the shaft member in a rotatable manner;
a vertical drive mechanism configured to drive the shaft member to vertically move with respect to the body; and
an inclined cam mechanism provided between the shaft member and the body and configured to rotate the shaft member in accordance with a vertical movement of the shaft member.
